(19) United States
(12) Patent Application Publication
(10) Pub. No.: US 2021/0214252 A1
(43) Pub. Date: Jul. 15, 2021

(54) AERATION SYSTEMS AND KITS FOR AERATION SYSTEMS AND METHODS FOR MAKING AND USING THE SAME

(71) Applicant: Christopher Scott Keever, Peachtree City, GA (US)

(72) Inventor: Christopher Scott Keever, Peachtree City, GA (US)

(21) Appl. No.: 17/145,461

(22) Filed: Jan. 11, 2021

Related U.S. Application Data
(60) Provisional application No. 62/959,651, filed on Jan. 10, 2020.

(51) Int. Cl. C02F 3/08; C02F 3/06; C02F 3/10

(52) U.S. Cl. CPC C02F 3/087; C02F 3/10; C02F 3/06

(57) ABSTRACT

Aeration systems and kits for aeration systems are disclosed. Methods of making and using aeration systems and kits for aeration systems are also disclosed.

### CROSS-REFERENCE TO RELATED APPLICATIONS

This patent application claims the benefit of priority to U.S. Provisional Patent Application Ser. No. 62/959,651 filed on Jan. 10, 2020 and entitled “AERATION SYSTEMS AND KITS FOR AERATION SYSTEMS AND METHODS OF MAKING AND USING THE SAME,” the subject matter of which is hereby incorporated by reference in its entirety.

### FIELD OF THE INVENTION

The present invention relates generally to aeration systems and kits for aeration systems. The present invention further relates to methods of making and using aeration systems and kits for aeration systems.

### BACKGROUND OF THE INVENTION

In the treatment of water, there are many different process configurations, methods, and designs for removing contaminants. Wastewater treatment processes grow different kinds of bacteria and subject the bacteria to specific conditions that maximize their multiplication and hence their ability to remove contaminants. Some are fixed film processes whereby the bacteria grow on a substrate and contact with the water. Others are suspended growth processes where the bacteria are free-floating in the water. Each process has advantages and disadvantages, and solutions are chosen based on capability, resiliency, footprint, capital cost, total installed cost, operational costs and complexity, maintenance costs and complexity, and many other factors.

One method of treating wastewater includes the use of floating, fixed-film biological “carriers”, sometimes called biomedia or bio-carriers. This media is of a specific gravity that typically allows it to float and move freely throughout a tank. The contaminants within the wastewater contact with the bio-carriers (and activated sludge) and are removed. Treated water then exits the tank through screens that allow the passage of water, but not the biocarriers (media). It should be noted that the industry typically calls this type of biological treatment process an Integrated Fixed-Film Activated Sludge (IFAS) Process or Moving Bed Biofilm Reactor (MBBR) Process. See, FIGS. 1-5.

IFAS and MBBR systems have notable advantages over other biological treatment methods. The key benefit is that they typically increase the capacity and/or contaminant removal capability of a plant without adding additional tankage. By retrofitted into existing tankage, the capital and construction cost of new tankage is eliminated. Additionally, these processes are often considered more robust and resilient in terms of their ability to accommodate variations in incoming contaminants and loadings. For the above reasons, they are high-value treatment solutions—particularly with plants needing slightly greater treatment capacity.

In new construction, IFAS and MBBR systems have smaller footprints than many other biological treatment processes and therefore can have attractive total installed costs. However, most of the time these systems are considered predominantly for retrofit applications.

IFAS and MBBR systems also have at least the following disadvantages:

1. Civil Modifications & Costs—Although these systems typically eliminate the need for additional tankage, they still require civil works/modifications to existing tankage. Baffle walls are oftentimes needed to create specific zones of treatment. Media retention screens must be installed to prevent the exit of the biocarriers from each treatment zone. Additional or modified fine-bubble or coarse-bubble aeration equipment is oftentimes needed to provide adequate oxygenation of the biomass and cleaning (movement) of the media. This aeration equipment is typically installed on the floor of a basin. Blowers associated with the aeration equipment must be installed—as well as the air-header piping to the diffusers in the basin. Finally, control systems are oftentimes needed. These components are expensive both from a capital and installation standpoint.
2. Process Disruption—Retrofitting these systems into existing tankage requires that a process train of a treatment plant be taken offline. This can hinder a plant's ability to treat the incoming wastewater. Retrofits of existing tankage can only be accomplished at certain low flow periods of the year—if at all.
3. Maintenance & Headloss—Media retention screens can become clogged with rags and debris and therefore must be cleaned. Additionally, not only does this become a maintenance burden at a facility, it also can create a headloss bottleneck in the treatment process—potentially causing everything upstream to spill outside the tanks. This would be a major problem to a utility or industrial customer as a spill of wastewater onto the ground is a serious violation typically carrying fines and a public relations mess.
4. Access to Aeration Equipment—With the aeration equipment installed and fixed on the floor of a tank, and the media installed (above it) in the tank, the only way to access the aeration equipment for inspection and maintenance is to remove the media. Considering the volume of media installed in these basins, the removal and storage of this (biologically active) media is cumbersome and problematic.
5. Biocarrier Size and Shape—Because the biocarriers must be large enough to not pass through the media retention screens, and the openings within the media retention screens are preferably large(r) so as to minimize fouling, cleaning frequency, and headloss, the surface area and biological treatment capacity of the biocarriers are limited. This drives the media size and shape towards larger, disc-like configurations. See, FIG. 4.
6. Biofilm Thickness and Process Control—These systems grow biomass on and within the media. The thickness of the biofilm is important and must be managed in order to grow certain kinds of bacteria and accomplish specific treatment objectives. The way this is accomplished is the media is put into motion (typically with air) and knocked around and into each other so that biomass sloughs off and nutrients and/or oxygen can diffuse appropriately to and through the biomass. Because the media is always in motion and knocking into one another, the ability to control biofilm thickness is limited and very much dependent on the shape and design of the media. Different medias have different capabilities to remove select contaminants.

It would therefore be ideal to be able to upgrade the treatment capability and/or capacity of a water treatment facility through the implementation of an apparatus and method for removing contaminants whereby one or more or all of the following advantages are achieved:

1. existing infrastructure could be utilized;
2. minimal civil works and/or modifications to an existing facility are required;
3. no media retention screens are required;
4. no headloss is added within a treatment process to accomplish treatment;
5. implementation could occur without shutting down or disrupting treatment in the existing facility;
6. a floating media is utilized within the process and is of a design, size and configuration that would allow maximum removal of contaminants per unit volume of media;
7. water from various points along the treatment process can be selected and/or mixed and treated so that specific contaminants may be more effectively removed;
8. a fixed-film biological process is utilized; and
9. the biofilm thickness could be controlled by selectively cleaning/scouring the media rather than continuously cleaning the media;

There is a need in the art for effective aeration systems and kits for aeration systems.

### SUMMARY OF THE INVENTION

The present invention is directed to aeration systems and kits for aeration systems. In some embodiments, the kit of the present invention may be used to retrofit an existing aeration system by providing a new, supplemental feature/component to the existing aeration system. In other embodiments, the kit of the present invention may be used to form a new aeration system.

In some embodiments, the kit of the present invention a kit for retrofitting, upgrading or providing an aeration system suitable for use at a wastewater treatment facility, wherein the kit comprises: a biomedia containment kit member, the biomedia containment kit member (a) comprising (i) an inner containment surface, (ii) an outer containment surface, and (iii) a containment material separating said inner containment surface from said outer containment surface, and (b) being sized so as to (i) be positionable within a body of water, and (ii) provide restricted movement of biomedia within a biomedia boundary space at least partially bound by said inner containment surface. The kits of the present invention may comprise one or more additional kit components. Suitable additional kit components include, but are not limited to, one or more aerators, one or more floats, one or more pumps, one or more water flowlines, biomedia, one or more water tanks, one or more support structure components, and any combination thereof.

The present invention is further directed to methods of making aeration systems and kits for aeration systems. In some embodiments, the method of making a kit comprises: combining one or more kit components selected from: the herein described biomedia containment kit member, one or more aerators, one or more floats, one or more pumps, one or more water flowlines, biomedia, one or more water tanks, one or more support structure components, and any combination thereof.

The present invention is even further directed to methods of using aeration systems and kits for aeration systems. In some embodiments of the present invention, the method of using a kit for an aeration system comprises treating water by passing the water through the herein described biomedia containment kit member.

These and other features and advantages of the present invention will become apparent after a review of the following detailed description of the disclosed embodiments and the appended claims.

### BRIEF DESCRIPTION OF THE FIGURES

The present invention is further described with reference to the appended figure, wherein:

FIG. 1 depicts a conventional Integrated Fixed-Film Activated Sludge (IFAS) system of the prior art;

FIG. 2 depicts a conventional Moving Bed Biofilm Reactor (MBBR) system of the prior art;

FIG. 3 depicts a view of an exemplary aeration piping layout that can be used in conventional IFAS and MBBR systems;

FIG. 4 depicts multiple views of conventional biocarriers (also referred to herein as “media”) used in conventional IFAS and MBBR systems;

FIG. 5 depicts a view of an exemplary IFAS and MBBR system in operation;

FIG. 6 depicts a view of an exemplary screen used in conventional IFAS and MBBR systems;

FIG. 7 depicts a view of an exemplary floating bed reactor aeration system of the present invention;

FIG. 8 depicts a view of an exemplary aeration containment system of the present invention;

FIG. 9 depicts a view of another exemplary floating bed reactor aeration system of the present invention;

FIG. 10 depicts a view of another exemplary floating bed reactor aeration system of the present invention;

FIG. 11 depicts exemplary biocarriers (also referred to herein as “media”) of the present invention; and

FIG. 12 depicts a view of another exemplary floating bed reactor aeration system of the present invention.

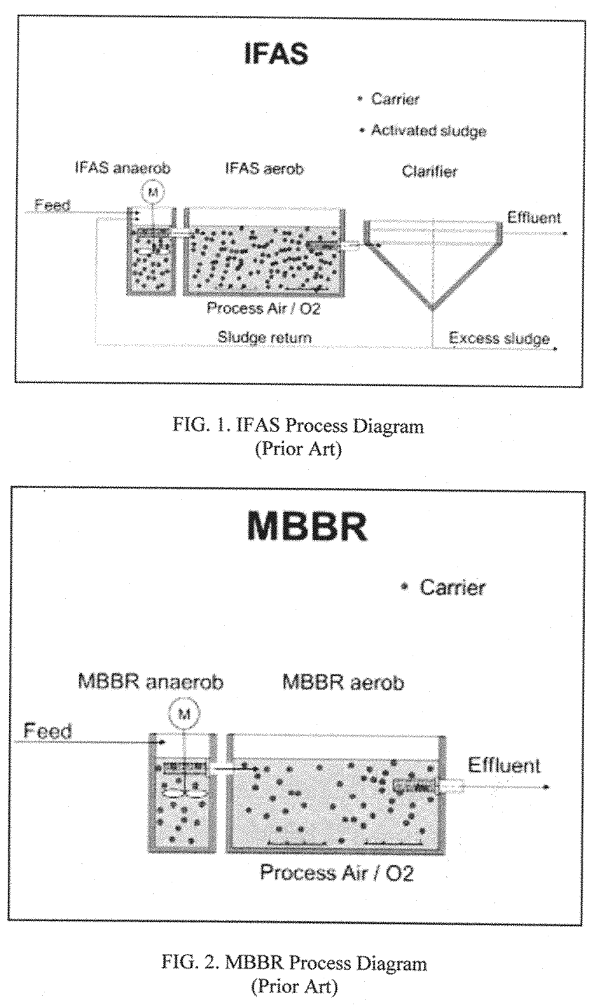

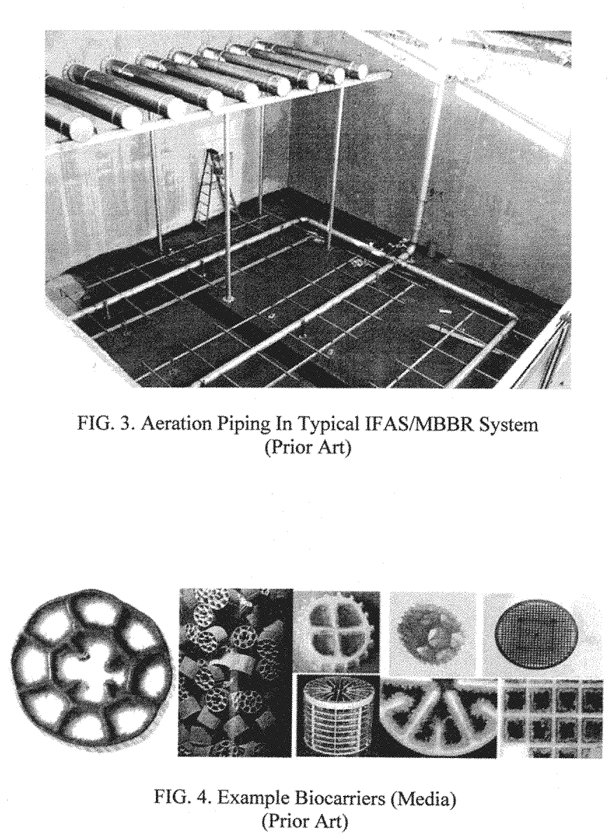

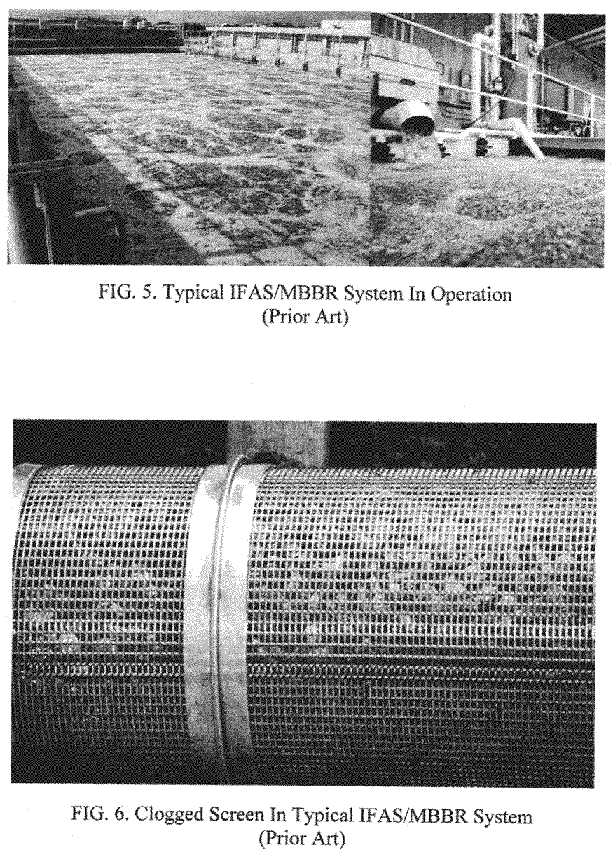

### DETAILED DESCRIPTION OF THE INVENTION

The present invention is directed towards aeration systems 200 and kits 100 for aeration systems 200. The present invention is further directed to methods of making aeration systems 200 and kits 100 for aeration systems 200. The present invention is even further directed towards methods of using aeration systems 200 and kits 100 for aeration systems 200.

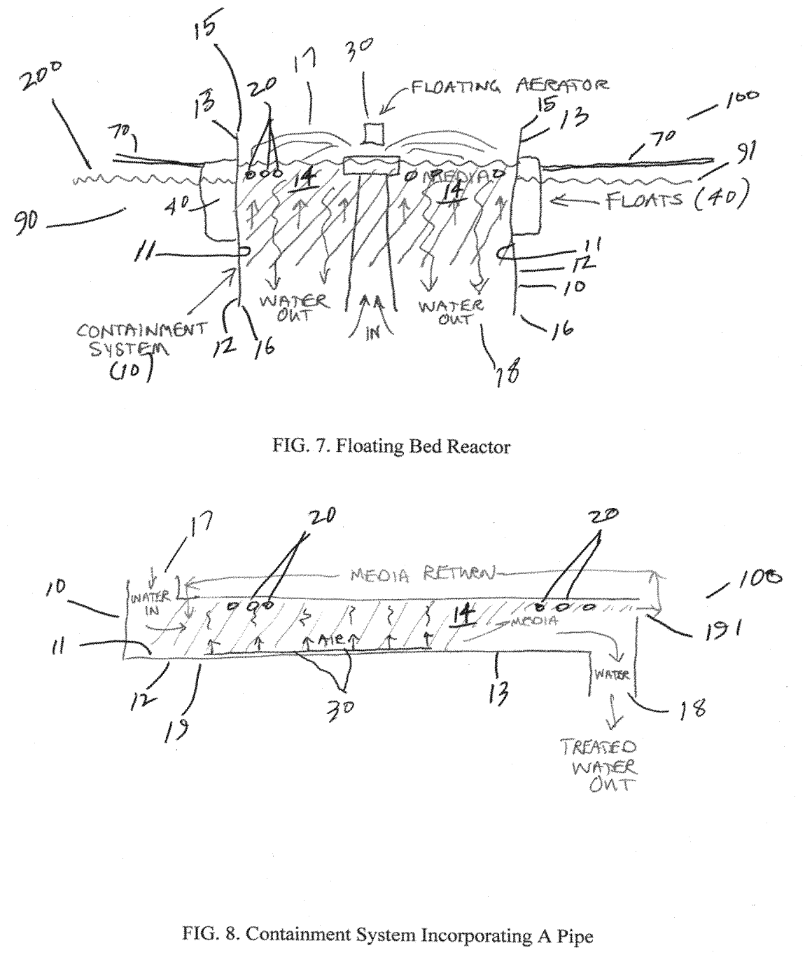

In some embodiments, the present invention is directed to water treatment systems that incorporates floating media 20 (i.e., biocarriers or biomedia), a containment system 10 for the floating media 20, a means to introduce water to the floating media 20 whereby contact and detention time between the water and floating media 20 is maximized, and a means to allow water to exit the process while retaining the floating media 20. In some desired embodiments, the aeration systems 200 and kits 100 for aeration systems 200 utilize floating media 20 that is retained within the system through its buoyancy and resistance to sink and travel downward with the flow of water—combined with lateral containment by the herein-described biomedia containment kit member 10. The biomedia containment kit member 10 can float on the surface 91 of a body of water 90 or be installed on the shore/ground. See, for example, FIG. 7.

By using biomedia 20 buoyancy and lateral containment via the herein-described biomedia containment kit member 10 as the mechanism for retainage of the biomedia 20, the herein-described biomedia containment kit member 10 eliminates the need for media retention screens. This eliminates any issues associated with debris fouling of the screens and headloss in the system. The herein described biomedia containment kit member 10, as an isolated floating treatment system, adds zero headloss to an existing process.

The biomedia containment kit members 10 of the present invention can have various designs and configurations. One biomedia containment kit member 10 of the present invention is a floating “corral” or boom with an opening/exit below the floating media 20, as shown in FIG. 7. In this configuration, the biomedia containment kit member 10 extends above the water surface 91, and sufficiently deep in the basin 90 to ensure the buoyant biomedia 20 does not escape when the biomedia 20 is stationary or put into movement.

Another biomedia containment kit member 10 is a shore-mounted tank 80 of similar design. Another biomedia containment kit member 10 is a pipe 19 whereby water and biomedia 20 is introduced at one end; contact between the water and the biomedia 20 occurs along the length of the pipe 19; aeration within the pipe 19 may also occur; and the biomedia 20 is separated from the flow through its buoyancy by rising to the top of the water within the pipe 19 while water exits below the biomedia 20. See, for example, FIG. 8.

A biomedia containment kit member 10 may be utilized in its most typical application as a biological treatment system for the removal of wastewater contaminants such as BOD, TSS, Ammonia, Nitrogen, and Phosphorus. However, the methods and biomedia containment kit members 10 may also be utilized for the removal of contaminants in drinking water systems. For example, the biomedia 20 can be utilized to capture floc and clarify/filter water. It can also be seeded with activated carbon and used as a carbon contactor.

Water to be treated by the biomedia containment kit member 10 is introduced to the reactor/aeration system 200 above the biomedia 20 (i.e., above the water surface 91) or within the biomedia 20 (i.e., below the water surface 91). Ideally, contaminated water is distributed throughout the reactor/aeration system 200 so that it may travel evenly and slowly down/through the entire cross-section of biomedia 20 to maximize contact with the biomedia 20 and remove contaminants. There are several methods to accomplish this including, but not limited to, floating aerators/mixers within the biomedia containment kit member 10 (FIG. 7), submersible pumps 42, shore-mounted pumps 42, and so forth. It may be that the biomedia 20 is put into circulation or a desired level of motion (temporarily or permanently) to accentuate contact between the biomedia 20 and contaminants or scouring/cleaning of the biomedia 20.

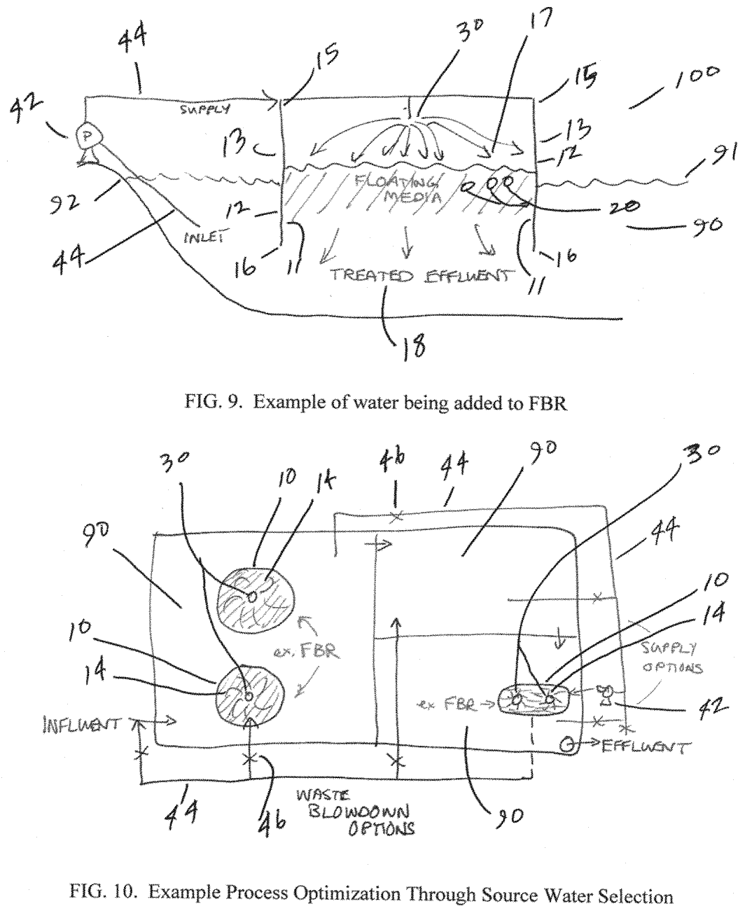

Aeration of the supply water may occur as part of the introduction of water to the reactor/aeration system 200. Screening of the water may also occur as part of the introduction of water to the reactor/aeration system 200. See, for example, FIG. 9.

Actively selecting water to be sent to the biomedia containment kit member 10 for treatment is a specific embodiment of the present invention. Water may be extracted from a select depth in the water column, or location within the entire treatment process, to accomplish a specific treatment objective. For example, water near the surface 91 in one location within a lagoon 90 may have high levels of dissolved oxygen from photosynthesis that could respirate bacteria within the biomedia containment kit member 10. Water of a preferred temperature or density may be selected and sent to the biomedia containment kit member 10. Nutrient rich water from deep in a basin 90 could be supplied as well. Biomass or microorganisms from certain areas of a plant process may be sent to the biomedia containment kit member 10 for use in the process. Combinations, batch treatment, or sequencing in the delivery of select water could be accomplished. BOD removal, nitrification, de-nitrification, and phosphorus removal can be accomplished and accentuated through this unique mechanism of delivering selected water to the biomedia containment kit member 10.

Solids generated from within an aeration system 200 may also be harvested and sent to select locations within a process/plant and/or treatment device. For example, the solids from an aeration system 200 accomplishing nitrification may be sent to the front end of a wastewater treatment facility to another aeration system 200 whereby denitrification could occur. See, for example, FIG. 10.

Biomedia:

Any floating media 20 or biomedia 20 or biocarrier 20 with a sufficiently low density can be utilized within the aeration systems 200 and kits 100 for aeration systems 200 of the present invention. The elimination of the need for biomedia retention screens (i.e., physical barrier separation) allows the aeration systems 200 and kits 100 for aeration systems 200 of the present invention to utilize any sufficiently buoyant biomedia 20 of any size. The aeration systems 200 and kits 100 for aeration systems 200 of the present invention are therefore able to utilize much smaller biomedia 20 than other biological fixed-film processes. The smaller the biomedia 20, the greater the potential of the biomedia 20 to accomplish treatment per unit volume. The aeration systems 200 and kits 100 for aeration systems 200 of the present invention can therefore potentially use less biomedia 20 to accomplish a treatment object or accomplish higher levels of contaminant removal.

In some embodiments, the biomedia 20 has a largest dimension and any dimension (e.g., height, length, width, or diameter) of less than about 50 millimeters (mm), more typically, less than about 25 mm. In particular, the biomedia 20 may have any dimension (e.g., height, length, width, or diameter), independently from about 1.0 mm to about 50 mm, in increments of 0.1 mm, e.g., 10.8 mm, or any range of dimensions from about 1.0 mm to about 50 mm, in increments of 0.1 mm, e.g., from 2.4 mm to about 8.7 mm.

Biocarriers 20 in the aeration systems 200 and kits 100 for aeration systems 200 of the present invention are desirable buoyant enough and of a sufficiently low specific gravity so as to not sink when loaded with biomass. Whereby biomedia in an IFAS/MBBR system must be slightly buoyant due to the necessity for it to mix throughout the basin 90 when aerated/mixed, this does not have to occur in the aeration systems 200 and kits 100 for aeration systems 200 of the present invention. It is therefore a specific embodiment of the present invention to utilize low-density polyethylene (LDPE) and/or other low-density materials as biomedia 20.

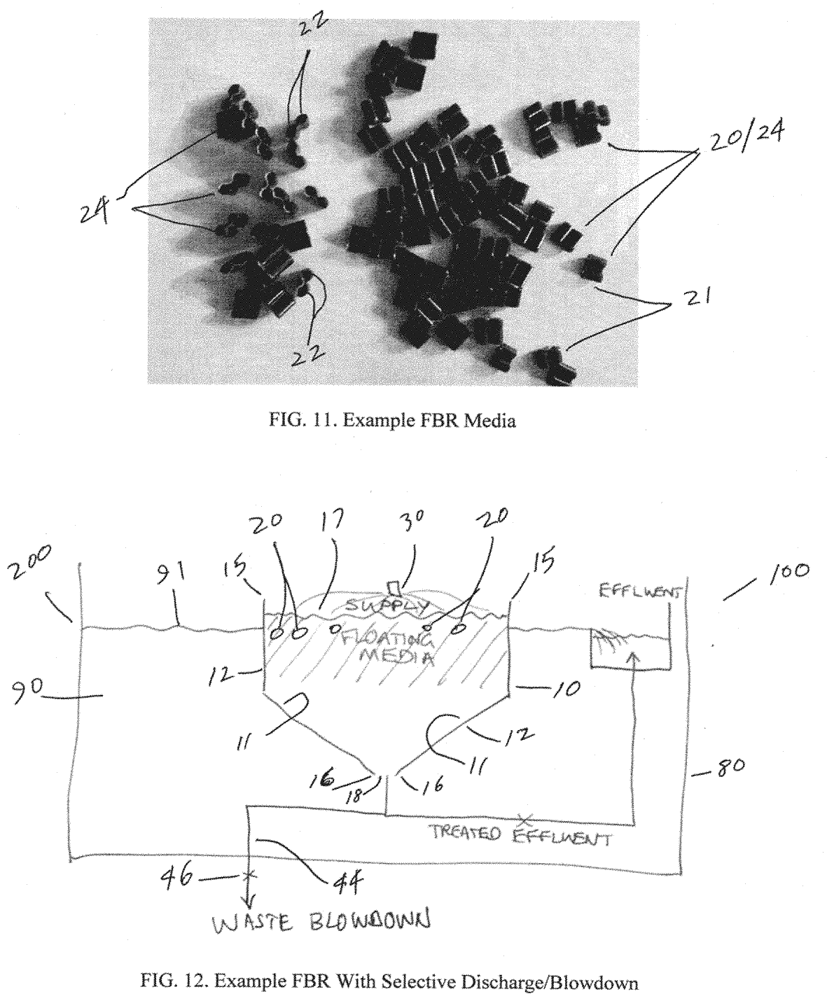

It is a specific embodiment of the present invention to utilize tubular or straw-like biomedia shapes/portions 24 of select length beneficial to the aeration treatment process 200. This biomedia 20 may have a single “barrel” (i.e., channel 22) or multiple “barrels” 22 connected together (ex. FIG. 11), forming beneficial surfaces for microbial growth within the openings, crevices, and on the biomedia 20. It is particularly beneficial to have multiple connected barrels 22, and preferably two barrels 22, where crevices are formed between the barrels 22 protecting bacterial growth. This biomedia 20 may also be cut lengthwise or into various alternative shapes, or ground into fine curved pieces 24 in order to maximize treatment performance of the biomedia 20. The tubular biomedia 20 may be any length or diameter, but preferentially it may be as long as 6 mm and as short at 0.1 mm and have a diameter of 0.1 mm to 6 mm.

It is a specific embodiment of the present invention to utilize biomedia 20 manufactured from floating plastic 20 harvested from the ocean or recycled plastics.

It is a specific embodiment of the present invention to utilize natural floating materials, such as wood or cork, as biomedia 20.

It is a specific embodiment of the present invention to potentially mix biomedia 20 of different sizes, shapes, or materials to accentuate treatment within aeration systems 200. For example, some biomedia 20 may have a shape and size for optimal nitrification while other biomedia 20 may be more effective at BOD removal.

Biofilm/Solids Management:

The aeration systems 200 and kits 100 for aeration systems 200 of the present invention provide a unique capability to manage biofilm thickness and retention of solids. Unlike IFAS/MBBR systems that are continuously mixed and therefore rely largely on the media shape to house and retain select microorganisms, the aeration systems 200 and kits 100 for aeration systems 200 of the present invention can control biofilm thickness by putting the biocarriers/biomedia 20 into motion selectively. Depending on the application, the biocarriers/biomedia 20 may be sloughed continuously, at time intervals, or not at all. This allows the aeration systems 200 to have great control over the amount and type of biomass growing on and within the biocarriers/biomedia 20.

There are several methods to managing biofilm thickness in a given aeration system 200. Whichever approach is used, enough energy must be enacted on the biocarriers/biomedia 20 to slough off biomass. It is also desirable to be careful not to damage the biocarriers/biomedia 20 in this process. One method may be to utilize mixers (not shown) within the aeration system 200. Another may be to extract the biomedia 20 out of the aeration system 200 and subject it to a high-energy device (e.g., a pump 42) that sloughs biomass from the biomedia 20 and returns it to the aeration system 200.

The biomass and/or solids that are sloughed off the biomedia 20 may exit out the aeration system 200 (e.g., a bottom of the aeration system 200) or be separated outside the aeration system 200. See, for example, FIG. 12.

A specific embodiment of the present invention is the utilization of a floating aerator 30 within the aeration system 200 to manage biofilm thickness and/or aeration. The floating aerator 30 may be utilized to oxygenate water that is sent out over and/or within the biomedia 20, slough off biomass from the biomedia 20, and/or send biomedia 20 into the air for oxygenation.

Other Applications:

The aeration systems 200 and kits 100 for aeration systems 200 may be used in water purification processes for the treatment of wastewater, process water, and drinking water. Their unique capability to grow and manage biofilms make the aeration systems 200 and kits 100 for aeration systems 200 of the present invention ideal for biological treatment applications. Biological treatment applications exist predominantly in wastewater treatment, but can exist in drinking water or process water applications as well. For example, biological treatment of dissolved organic carbon (DOC) and even taste and odor compounds can be found in drinking water processes. Because aeration systems 200 and kits 100 for aeration systems 200 can use biomedia 20 of pretty much any shape or size (desirably with sufficient buoyancy), the aeration systems 200 and kits 100 for aeration systems 200 of the present invention can accomplish a variety of treatment objectives.

In summary, the present invention is directed to kits 100 that may be used to retrofit/upgrade/provide an existing wastewater treatment facility. One kit 100 of the present invention is represented in FIG. 7, and comprises (1) floating media 20 having limited lateral movement within the body of water 90 due to (2) a floating media containment kit member 10, the floating media containment kit member 10 (i) surrounding an existing aerator 30, and (ii) limiting movement of the floating media 20 within the boundaries of the floating media containment kit member 20 (i.e., the interior surface 11 of the floating media containment kit member 10). The floating media 20 used in this invention typically have a basis weight less than the basis weight used for standard, known floating media 20. Unlike standard, known floating media 20, the floating media 20 used in the present invention typically remains on the surface 91 of the water 90 (i.e., are not forceably moved throughout the water mass). In one embodiment, the floating media 20 used in the present invention comprises cut plastic (LDPE) straws 24, or other floating media 20 of a similar size having a length of less than ¼ inch.

The floating media containment kit member 10 can be a sheet of metal or plastic/polymer 13 that can be positioned so as to (i) surround an existing aerator 30, and (ii) form a barrier, limiting lateral movement of the floating media 20. The sheet 13 would have connectors (e.g., lips, nuts, bolts, slots, etc.) (not shown) so as to enable connection of one end (or end portion) to an opposite end (or end portion) (i.e., to form a tubular configuration). The sheet 13 can have multiple connectors so that a user can choose a desired perimeter/size of containment system 10. The sheet 13 could be buoyant or float, or the sheet 13 may further comprise one or more floats 40 that keep the sheet 13 at and above the surface 91 of the water 90.

In another embodiment shown in FIG. 8, the floating media containment kit member 10 comprises a pipe 19 or pipe system with numerous pipes 19, wherein the pipe/piping 19 limits movement of the floating media 20 within the pipe/piping 19, and promotes contact between water and the floating media 20. This system could be positioned on-ground and/or along the surface of a water reservoir 90.

See also, FIG. 9, which shows another possible kit 100 component is the form of an aerator 30 positionable above a floating media containment kit member 10. In this embodiment, select water (e.g., having a certain temperature, a high oxygen content, etc.) is introduced above and onto the floating media 20.

All of these embodiments have the ability to clean the biomedia 20 and control, through the cleaning, the amount of biological growth and hence the weight and buoyancy of the biomedia 20.

The aeration systems 200 and kits 100 for aeration systems 200 and methods of making and using aeration systems 200 and kits 100 for aeration systems 200 are further described in the following embodiments.

### Additional Embodiments

Aeration Systems and Kits for Aeration Systems

1. A kit 100 for retrofitting, upgrading or providing an aeration system 200 suitable for use at a wastewater treatment facility, said kit 100 comprising: a biomedia containment kit member 10, the biomedia containment kit member 10 (a) comprising (i) an inner containment surface 11, (ii) an outer containment surface 12, and (iii) a containment material 13 separating said inner containment surface 11 from said outer containment surface 12, and (b) being sized so as to (i) be positionable within a body of water 90, and (ii) provide restricted movement of biomedia 20 within a biomedia boundary space 14 at least partially bound by said inner containment surface 11.
2. The kit 100 of embodiment 1, wherein said containment material 13 comprises at least one sheet of material 13.
3. The kit 100 of embodiment 1 or 2, wherein said containment material 13 comprises a cellulosic material, a metal, a polymer, or any combination thereof.
4. The kit 100 of any one of embodiments 1 to 3, wherein at least a portion of said containment material 13 comprises an aperture-containing material 13 that allows water to flow therethrough.
5. The kit 100 of any one of embodiments 1 to 4, wherein all of said containment material 13 comprises an aperture-containing material 13 that allows water to flow therethrough.
6. The kit 100 of any one of embodiments 1 to 5, wherein said containment material 13 comprises a netting or mesh material 13.
7. The kit 100 of any one of embodiments 1 to 4 and 6, wherein at least a portion of said containment material 13 comprises a continuous material 13 that does not allow water to flow therethrough.
8. The kit 100 of any one of embodiments 1 to 3 and 7, wherein all of said containment material 13 comprises a continuous material 13 that does not allow water to flow therethrough.
9. The kit 100 of any one of embodiments 1 to 8, wherein said containment material 13 is positioned so as to have a tubular configuration with said inner containment surface 11 forming an inner surface of the tubular configuration, and said outer containment surface 12 forming an outer surface of the tubular configuration. See, for example, FIGS. 7-10 and 12.
10. The kit 100 of embodiment 9, wherein said tubular configuration extends perpendicular to an upper surface 91 of the body of water 90.
11. The kit 100 of embodiment 9 or 10, wherein an upper end 15 of said containment material 13 extends above the upper surface 91 of the body of water 90. See, for example, FIGS. 7, 9 and 12.
12. The kit 100 of any one of embodiments 9 to 11, wherein a lower end 16 of said containment material 13 extends below the upper surface 91 of the body of water 90.
13. The kit 100 of any one of embodiments 1 to 12, wherein said biomedia containment kit member 10 is sized to surround at least one aerator 30 positionable within the body of water 90 so as to restrict movement of biomedia 20 between the at least one aerator 30 and said inner containment surface 11.
14. The kit 100 of any one of embodiments 1 to 13, wherein said biomedia containment kit member 10 has a water inlet 17 and a water outlet 18.
15. The kit 100 of embodiment 14, wherein the water inlet 17 and the water outlet 18 have substantially similar (e.g., equal) cross-sectional areas.
16. The kit 100 of embodiment 14, wherein the water inlet 17 is large in cross-sectional area than the water outlet 18.
17. The kit 100 of any one of embodiments 1 to 16, wherein the body of water 90 comprises a pond or reservoir 90.
18. The kit 100 of any one of embodiments 1 to 16, wherein the body of water 90 comprises water within a water tank 80 positioned on land.
19. The kit 100 of any one of embodiments 1 to 3, 7 to 9, 11 to 12 and 14 to 18, wherein said containment material 13 comprises a pipe 19.
20. The kit 100 of embodiment 19, wherein said pipe 19 comprises a biomedia outlet 191 separate from said water outlet 18 of said biomedia containment kit member 10.
21. The kit 100 of any one of embodiments 1 to 20, wherein said kit 100 further comprises: one or more aerators 30.
22. The kit 100 of embodiment 21, wherein at least one of said one or more aerators 30 comprises a floating aerator 30. See, for example, FIG. 7.
23. The kit 100 of embodiment 21 or 22, wherein at least one of said one or more aerators 30 comprises a suspended aerator 30 positioned above said biomedia containment kit member 10 and the body of water 90. See, for example, FIG. 9.
24. The kit 100 of any one of embodiments 21 to 23, wherein at least one of said one or more aerators 30 comprises a submerged aerator 30 positioned within the body of water 90.
25. The kit 100 of any one of embodiments 21 to 24, wherein at least one of said one or more aerators 30 comprises a contained aerator 30 substantially surrounded by said inner containment surface 11 of said biomedia containment kit member 10. See, for example, FIG. 8.
26. The kit 100 of any one of embodiments 1 to 25, wherein said kit 100 further comprises: one or more floats 40, said one or more floats 40 being sized so as to be able to maintain said biomedia containment kit member 10 at an upper surface 91 of the body of water 90. See, for example, FIG. 7.
27. The kit 100 of any one of embodiments 1 to 26, wherein said kit 100 further comprises: one or more pumps 42, and one or more water flowlines 44, said one or more pumps 42 and said one or more water flowlines 44 being configured and operatively adapted to move water from a water source to at least one of: (i) a water inlet 17 of said biomedia containment kit member 10, (ii) an aerator 30 proximate to or within said biomedia containment kit member 10, (iii) a treated water discharge outlet 18, and (iv) one or more water tanks 80. A given kit 100 may further comprise one or more valves 46 such as valves 46 shown in FIGS. 10 and 12.
28. The kit 100 of embodiment 27, wherein the water source comprises: (i) water to be treated, (ii) water that has been treated, (iii) water having a relatively high oxygen content, (iv) water having a desired water temperature, (v) water from a particular depth from within a water pond or reservoir 90, or (vi) any combination thereof.
29. The kit 100 of any one of embodiments 1 to 28, wherein the kit 100 comprises two or more of the above-described biomedia containment kit members 10.
30. The kit 100 of any one of embodiments 1 to 29, wherein said kit 100 further comprises: biomedia 20.
31. The kit 100 of embodiment 30, wherein said biomedia 20 comprises a plurality of biomedia structures 21, each biomedia structure 21 comprising a three-dimensional shape having a structure length, a structure width, and a structure height. See, for example, FIG. 11.
32. The kit 100 of embodiment 30 or 31, wherein said biomedia 20 comprises a plurality of biomedia tubular structures 21 with each biomedia tubular structure 21 having one or more channels 22 extending therethrough. See again, for example, FIG. 11.
33. The kit 100 of any one of embodiments 30 to 32, wherein said biomedia 20 comprises a plurality of biomedia tubular structures 21 with each biomedia tubular structure 21 comprising a plastic straw portion 24. See again, for example, FIG. 11.
34. The kit 100 of any one of embodiments 30 to 33, wherein said biomedia 20 comprises low-density polyethylene (LDPE).
35. The kit 100 of any one of embodiments 30 to 34, wherein said biomedia 20 has (i) an overall length of up to or less than about 6 mm, and (ii) an overall width or diameter of up to or less than about 6 mm.
36. The kit 100 of any one of embodiments 1 to 35, wherein said kit 100 further comprises: one or more water tanks 80, each water tank 80 being independently sized to house a quantity of water.
37. The kit 100 of any one of embodiments 1 to 36, wherein said kit 100 further comprises: one or more support structure components 70, said one or more support structure components 70 being operatively adapted and sized to connect to and position said biomedia containment kit member 10 relative to (i) the body of water 90, (ii) an outer water periphery 92 of the body of water 90, (iii) an aerator 30, (v) a water tank 80, or (iv) any combination thereof.
38. The kit 100 of embodiment 37, wherein said one or more support structure components 70 connect to an aerator 30.
39. The kit 100 of embodiment 37 or 38, wherein said one or more support structure components 70 connect to land structure (not shown) positioned proximate or beyond the outer water periphery 92 of the body of water 90.

Methods of Making Aeration Systems and Kits for Aeration Systems

40. A method of making the kit 100 of any one of embodiments 1 to 39, said method comprising: combining one or more of: the biomedia containment kit member 10, the one or more aerators 30, the one or more floats 40, the one or more pumps 42, the one or more water flowlines 44, the biomedia 20, the one or more water tanks 80, and the one or more support structure components 70.
41. The method of embodiment 40, further comprising: forming one or more of: the biomedia containment kit member 10, the one or more aerators 30, the one or more floats 40, the one or more pumps 42, the one or more water flowlines 44, the biomedia 20, the one or more water tanks 80, and the one or more support structure components 70.
42. The method of embodiment 40 or 41, further comprising: assembling with one another, one or more of: the biomedia containment kit member 10, the one or more aerators 30, the one or more floats 40, the one or more pumps 42, the one or more water flowlines 44, the biomedia 20, the one or more water tanks 80, and the one or more support structure components 70.

Methods of Using Aeration Systems and Kits for Aeration Systems

43. A method of using the kit 100 of any one of embodiments 1 to 39, said method comprising: treating water by passing the water through the biomedia containment kit member 10.
44. The method of embodiment 43, wherein said treating step further comprises: processing the water through the one or more aerators 30.
45. The method of embodiment 43 or 44, wherein said method further comprises: positioning the one or more floats 40 proximate the biomedia containment kit member 10 so as to maintain the biomedia containment kit member 10 at an upper surface 91 of the body of water 90.
46. The method of any one of embodiments 43 to 45, wherein said method further comprises: utilizing the one or more pumps 42 and the one or more water flowlines 44 to move the water through the biomedia containment kit member 10.
47. The method of any one of embodiments 43 to 46, wherein said method further comprises: positioning the biomedia 20 within the biomedia boundary space 14.
48. The method of any one of embodiments 43 to 47, wherein said method further comprises: utilizing the one or more support structure components 70 to position the biomedia containment kit member 10 relative to (i) the body of water 90, (ii) an outer water periphery 92 of the body of water 90, (iii) an aerator 30, (v) a water tank 80, or (iv) any combination thereof.
49. The method of embodiment 48, wherein the one or more support structure components 70 connect to an aerator 30.
50. The method of embodiment 48 or 49, wherein the one or more support structure components 70 connect to land structure (not shown) positioned proximate or beyond the outer water periphery 92 of the body of water 90.
51. The method of any one of embodiments 43 to 50, wherein said method further comprises: positioning the biomedia containment kit member 10 proximate to or within the one or more water tanks 80.
52. The method of any one of embodiments 43 to 51, wherein said method removes contaminants from the water.
53. The method of any one of embodiments 43 to 52, wherein said method removes contaminants from the water so as to form drinking water.

Biomedia Suitable for Use in Aeration Systems and Kits for Aeration Systems

54. Biomedia 20 comprising a plurality of biomedia tubular structures 21 with each biomedia tubular structure 21 comprising a plastic straw portion 24. See again, FIG. 11.
55. The biomedia 20 of embodiment 54, wherein the plastic straw portion 24 comprising a single channel 22 or a double channel 22 extending along a length of the plastic straw portion 24. It should be understood that plastic straw portion 24 may comprise any number of channels 22 extending along a length of the plastic straw portion 24.
56. The biomedia 20 of embodiment 54 or 55, wherein said biomedia 20 comprises low-density polyethylene (LDPE).
57. The biomedia 20 of any one of embodiments 54 to 56, wherein said biomedia 20 has (i) an overall length of up to or less than about 6 mm, and (ii) an overall width or diameter of up to or less than about 6 mm.

Systems Using Aeration Systems and Kits for Aeration Systems

58. A water treatment facility comprising the kit 100 of any one of embodiments 1 to 39 and/or the biomedia 20 of any one of embodiments 54 to 57.
59. A body of water 90 having the kit 100 of any one of embodiments 1 to 39 and/or the biomedia 20 of any one of embodiments 54 to 57 therein.
60. A water tank 80 having the kit 100 of any one of embodiments 1 to 39 and/or the biomedia 20 of any one of embodiments 54 to 57 therein.

In addition, it should be understood that although the above-described aeration systems 200 and kits 100 for aeration systems 200, methods of making aeration systems 200 and kits 100 for aeration systems 200, and methods of using aeration systems 200 and kits 100 for aeration systems 200 are described as “comprising” one or more components or steps, the above-described aeration systems 200 and kits 100 for aeration systems 200, methods of making aeration systems 200 and kits 100 for aeration systems 200, and methods of using aeration systems 200 and kits 100 for aeration systems 200 may “comprise,” “consists of,” or “consist essentially of” the above-described components of the aeration systems 200 and kits 100 for aeration systems 200, method steps of the methods of making aeration systems 200 and kits 100 for aeration systems 200, and method steps of the methods of using aeration systems 200 and kits 100 for aeration systems 200. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, an aeration system 200 or kit 100 for aeration system 200, a method of making an aeration system 200 or kit 100 for aeration system 200, or a method of using an aeration system 200 or kit 100 for aeration system 200 that “comprises” a list of elements (e.g., components or steps) is not necessarily limited to only those elements (or components or steps), but may include other elements (or components or steps) not expressly listed or inherent to the aeration system 200 or kit 100 for aeration system 200, the method of making the aeration system 200 or kit 100 for aeration system 200, and/or the method of using the aeration system 200 or kit 100 for aeration system 200.

As used herein, the transitional phrases “consists of” and “consisting of” exclude any element, step, or component not specified. For example, “consists of” or “consisting of” used in a claim would limit the claim to the components, materials or method steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define an aeration system 200 or kit 100 for aeration system 200, a method of making an aeration system 200 or kit 100 for aeration system 200, and/or a method of using an aeration system 200 or kit 100 for aeration system 200 that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described aeration systems 200 and kits 100 for aeration systems 200, methods of making aeration systems 200 and kits 100 for aeration systems 200, and/or methods of using aeration systems 200 and kits 100 for aeration systems 200 may comprise, consist essentially of, or consist of any of the herein-described components, method steps, and/or features, as shown in the figures with or without any feature(s) not shown in the figures. In other words, in some embodiments, the aeration systems 200 and kits 100 for aeration systems 200, methods of making aeration systems 200 and kits 100 for aeration systems 200, and/or methods of using aeration systems 200 and kits 100 for aeration systems 200 of the present invention do not have any additional features other than those shown in the figures, and such additional features, not shown in the figures, are specifically excluded from the aeration systems 200 and kits 100 for aeration systems 200, methods of making aeration systems 200 and kits 100 for aeration systems 200, and/or methods of using aeration systems 200 and kits 100 for aeration systems 200. In other embodiments, the aeration systems 200 and kits 100 for aeration systems 200, methods of making aeration systems 200 and kits 100 for aeration systems 200, and/or methods of using aeration systems 200 and kits 100 for aeration systems 200 of the present invention do have one or more additional features that are not shown in the figures.

The present invention is described above and further illustrated below by way of claims, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

What is claimed is:

1. A kit for retrofitting, upgrading, or providing an aeration system suitable for use at a wastewater treatment facility, said kit comprising:
a biomedia containment kit member, the biomedia containment kit member (a) comprising (i) an inner containment surface, (ii) an outer containment surface, and (iii) a containment material separating said inner containment surface from said outer containment surface, said containment material comprising at least one sheet of material comprising a cellulosic material, a metal, a polymer, or any combination thereof, and (b) being sized so as to (i) be positionable within a body of water, and (ii) provide restricted movement of biomedia within a biomedia boundary space at least partially bound by said inner containment surface.

2. The kit of claim 1, wherein at least a portion or all of said containment material comprises an aperture-containing material that allows water to flow therethrough.

3. The kit of claim 2, wherein said containment material comprises a netting or mesh material.

4. The kit of claim 1, wherein at least a portion of or all of said containment material comprises a continuous material that does not allow water to flow therethrough.

5. The kit of claim 4, wherein said containment material (a) is positioned so as to have a tubular configuration with said inner containment surface forming an inner surface of the tubular configuration, and said outer containment surface forming an outer surface of the tubular configuration, (b) extends perpendicular to an upper surface of the body of water, (c) comprises an upper end that extends above the upper surface of the body of water, and (d) comprises a lower end that extends below the upper surface of the body of water.

6. The kit of claim 1, wherein said biomedia containment kit member is sized to surround at least one aerator positionable within the body of water so as to restrict movement of biomedia between the at least one aerator and said inner containment surface.

7. The kit of claim 1, wherein said biomedia containment kit member has a water inlet and a water outlet, and (i) the water inlet and the water outlet have substantially equal cross-sectional areas, or (ii) the water inlet is larger in cross-sectional area than the water outlet.

8. The kit of claim 1, wherein the body of water comprises a pond or reservoir or water within a water tank positioned on land.

9. The kit of claim 1, wherein said containment material comprises a pipe, and said pipe comprises a biomedia outlet separate from a water outlet of said biomedia containment kit member.

10. The kit of claim 1, wherein said kit further comprises:
one or more aerators.

11. The kit of claim 10, wherein at least one of said one or more aerators comprises a floating aerator.

12. The kit of claim 10, wherein at least one of said one or more aerators comprises a suspended aerator positioned above said biomedia containment kit member and the body of water.

13. The kit of claim 10, wherein at least one of said one or more aerators comprises a submerged aerator positioned within the body of water.

14. The kit of claim 10, wherein at least one of said one or more aerators comprises a contained aerator substantially surrounded by said inner containment surface of said biomedia containment kit member.

15. The kit of claim 1, wherein said kit further comprises:
one or more floats, said one or more floats being sized so as to be able to maintain said biomedia containment kit member at an upper surface of the body of water.

16. The kit of claim 1, wherein said kit further comprises:
one or more pumps,
one or more water flowlines, and
optionally, one or more water tanks, each water tank being independently sized to house a quantity of water,
said one or more pumps and said one or more water flowlines being configured and operatively adapted to move water from a water source to at least one of: (i) a water inlet of said biomedia containment kit member, (ii) an aerator proximate to or within said biomedia containment kit member, (iii) a treated water discharge outlet, and (iv) one or more water tanks;
wherein the water source comprises: (i) water to be treated, (ii) water that has been treated, (iii) water having a relatively high oxygen content, (iv) water having a desired water temperature, (v) water from a particular depth from within a water pond or reservoir, or (vi) any combination thereof.

17. The kit of claim 1, wherein the kit comprises two or more of the above-described biomedia containment kit members.

18. The kit of claim 1, wherein said kit further comprises: biomedia, said biomedia (a) comprising a plurality of biomedia tubular structures with each biomedia tubular structure comprising a plastic straw portion, and (b) having (i) an overall length of up to or less than about 6 mm, and (ii) an overall width or diameter of up to or less than about 6 mm.

19. The kit of claim 1, wherein said kit further comprises:
one or more support structure components, said one or more support structure components being operatively adapted and sized to connect to and position said biomedia containment kit member relative to (i) the body of water, (ii) an outer water periphery of the body of water, (iii) an aerator, (v) a water tank, or (iv) any combination thereof,
wherein said one or more support structure components connect to (a) an aerator, or (b) a land structure positioned proximate or beyond the outer water periphery of the body of water.

20. A method of using the kit of claim 1, said method comprising:
treating water by passing the water through the biomedia containment kit member;
processing the water through one or more aerators;
positioning one or more floats proximate the biomedia containment kit member so as to maintain the biomedia containment kit member at an upper surface of the body of water;
utilizing one or more pumps and one or more water flowlines to move the water through the biomedia containment kit member;
positioning biomedia within the biomedia boundary space; and
utilizing one or more support structure components to position the biomedia containment kit member relative to (i) the body of water, (ii) an outer water periphery of the body of water, (iii) an aerator, (v) a water tank, or (iv) any combination thereof.
